(19) United States
(12) Patent Application Publication
(10) Pub. No.: US 2010/0277782 A1
(43) Pub. Date: Nov. 4, 2010

(54) Micromechanical Device and Method for Projecting Electromagnetic Radiation

(76) Inventors: Hans-Joachim Quenzer, Itzehoe (DE); Ulrich Hofmann, Itzehoe (DE); Marten Oldsen, Hamburg (DE)

Correspondence Address: FAY KAPLUN & MARCIN, LLP, 150 BROADWAY, SUITE 702, NEW YORK, NY, 10038, US

(21) Appl. No.: 12/668,140

(22) PCT Filed: Jul. 10, 2008
(86) PCT No.: PCT/EP08/06071

§ 371 Date: Jun. 14, 2010

(30) Foreign Application Priority Data
Jul. 10, 2007 (DE) 10 2007 032 801.1

(51) Int. Cl. G02B 26/10; G21K 5/04; G02B 26/08; H05B 3/00

(52) U.S. Cl. 359/204.2; 250/492.1; 250/494.1; 250/503.1; 359/197.1; 359/213.1; 219/201

(57) ABSTRACT

A micromechanical apparatus includes a moving element which comprises a controllable heating apparatus for introduction of a defined amount of heat into the moving element, wherein the apparatus furthermore has a control unit which is designed to control the heating apparatus as a function of an instantaneous temperature and/or of an instantaneous amount of heat that is introduced. The apparatus can be designed to project electromagnetic radiation when the moving element is in the form of a beam deflection unit for deflection of radiation, which originates from a radiation source, onto a projection surface.

The invention relates to a micromechanical device having a moveable element. This device can concern a device for projecting electromagnetic radiation which has an intensity-modulatable radiation source, the moveable element being designed then as a beam deflection unit. The invention relates furthermore to a corresponding method for projecting electromagnetic radiation according to the preamble of the coordinated claim.

Such a micromechanical device can be used for projecting electromagnetic radiation in that radiation emanating from the radiation source is deflected onto a projection surface, a time-dependent instantaneous projection direction being able to be prescribed by corresponding actuation of the beam deflection unit. Hence such a device can be used for example for image generation or also for surface processing of workpieces.

With moveable reflectors or else with moveable refractively- or diffractively-acting elements, electromagnetic radiation of the UV to IR wavelength range can be deflected specifically. Such beam deflection is important for example for transmission of one- or multidimensional image information (display tasks, e.g. laser projection) or else for material-processing tasks (e.g. laser writing).

One or more sources of electromagnetic radiation which can be controlled specifically temporally with respect to the output intensity provide one or more beams which are guided with the help of a uniaxial or multiaxial deflection system over the surface to be irradiated. An example of this can be a modulatable red-green-blue light source comprising three laser sources of different wavelengths, said light source being used for coloured image data projection and the combined output beam of which is deflected horizontally and vertically via a biaxial microscan mirror or alternatively via two successively disposed uniaxial microscan mirrors such that the deflected beam covers and illuminates a projection surface in the desired form. The beam deflection, as described in the publications U.S. Pat. No. 6,140,979 A and U.S. Pat. No. 7,009,748 B2, can be grid-shaped and produce a line-wise image structure, or else be effected in a circular or helical shape, as described in the publication U.S. Pat. No. 6,147,822A. In the publication WO 03/032046 A1, a similar projection system is described, which achieves an image structure in a Lissajous shape based on two resonant scan devices, the scan frequencies of which always differ by less than one order of magnitude. In the publication WO 2006/063577 A1, an image projection device is described which can produce the image structure both via grid-shaped scanning and via any Lissajous figures based on any ratios of the scan frequencies of a biaxial beam deflection system. The beam deflection unit actuated in any manner is thereby tracked continuously by an observation laser beam which impinges, after reflection on the beam deflection system, on a two-dimensional position-sensitive detector and, as a function of a thus measured instantaneous XY position, the intensity value associated with this position is read out of the image store and, corresponding to this value, a light source is actuated.

In all these known projection systems, the following problem occurs:

Since the information to be transmitted is generally intensity-coded, the respectively provided beam deflection device does not radiate temporally with a constant intensity. Since the beam deflection device always absorbs a non-infinitely small proportion of the incident radiation, the deflection device heats up as a function of the intensity of the incident beam. Conditional upon the temporally changing radiation intensity, the temperature of the beam deflection device hence also constantly varies. The changing temperature of the beam deflection device results however in the material, from which the beam deflection device is made, experiencing a volume change. This results in turn in the mechanical-dynamic properties of the beam deflection device changing at least slightly. If the beam defection device concerns for example torsion mirrors which are suspended on springs and operate resonantly, then the temperature-related volume changes lead to changes in the spring constants and hence to changes in the resonance frequency of this deflection device, but also simultaneously to changes in phase and amplitude of the mirror deflection. The result thereof can be that not all image information is projected towards the correct location and the size of the projected image also changes. Therefore undesired distortions arise. The portrayed problem occurs in particular when using uniaxial or multiaxial torsion microscan mirrors manufactured from silicon, such as described e.g. in DE 19941363 A1 or U.S. Pat. No. 6,595,055 B1 because the generally very thin spring suspensions do not allow sufficiently rapid heat dissipation.

In the publication WO 2005/015903 A1, it is proposed as a solution to the portrayed temperature problem to insert a shadowing element between intensity-modulated light source and projection- or processing surface such that it serves to mask the light beam during specific time intervals within the total duration of the projection. The time intervals, during which the light beam is masked via the shadowing element, is respectively available for temperature compensation. A control unit and control program control the modulation device in such a manner that an at least approximately constant average intensity of the light beam is produced over the entire projection time period.

The disadvantage of this arrangement is immediately evident: firstly, such a shadowing element has the effect that the entirety of the light which would be available in principle for image or information transmission cannot also be used for this purpose. This lesser efficiency of the light yield is not problematic for arrangements for material processing since this can be compensated for generally by the high available light powers of the light sources. In contrast, for mobile laser projection displays, especially for those which are battery-supplied, such poorer efficiency during light transmission can very possibly present an unacceptable problem. A further problem basically exists quite independently of the application: the invention described in the publication WO 2005/015903 A1 allows a temperature correction always only at specific points in time. The person skilled in the art can deduce from this proposed method that a projection display for image reproduction must have shadowing elements which are located at the edges of the image region and not in the middle of the image region. Hence the intended process for temperature compensation is restricted respectively to the regions of the return points of the deflection device. Hence a temperature stabilisation results only as an average over a comparatively very large time interval. It is thereby of great importance that a great deal of image information (pixels) can be projected perfectly well between two shadowing intervals. For example, in the case of an image projection with VGA resolution, at least 480 pixels, maximum even 640 pixels, are projected in one piece without the proposed method being able to react in the interim to any intensity variations within these projected pixels. With respect to small time intervals (few pixels), significant intensity- and temperature variations can therefore very possibly occur, which cannot be compensated for with this method. Within two shadowing events, the result can furthermore therefore be phase-, amplitude- and frequency variations. In order to ensure an image- or information transmission which is very true to the original, this method can therefore be inadequate especially in the case of high-resolution image information.

In publication U.S. Pat. No. 7,157,679 B2, a so-called “pattern dependent heating” of light sources is mentioned. Correction of the image data is proposed there to resolve the problem and is associated with a disadvantageously high computing complexity.

The object therefore underlying the invention is to develop a micromechanical device with which precision problems as a result of thermal influences on mechanical properties of moveable parts can be avoided. In particular the object also thereby underlying the invention is to develop a device for projecting electromagnetic radiation, which avoids the above-portrayed disadvantages, with low complexity. The device should permit in particular projection of prescribed patterns with high precision. Furthermore, the object underlying the invention is to develop a corresponding precise method for projecting electromagnetic radiation.

This object is achieved according to the invention by a device having the characterising features of the main claim in conjunction with the features of the preamble of the main claim and also by a method having the features of the coordinated claim. Advantageous embodiments and developments of the invention are revealed in the features of the sub-claims.

The object is therefore achieved in that the device comprises a controllable heating device for a defined heat input into the moveable element, the device having furthermore a control unit which is designed to control the heating device as a function of an instantaneous temperature and/or as a function of an instanteous different heat input into the moveable element. As a result, a uniform temperature-control of the moveable element can be achieved, with which it is avoided advantageously that mechanical properties of the moveable element, for example resonance properties, change because of temperature variations. The other heat input can thereby be caused for example by a radiation power of a radiation source directed towards the moveable element, in particular if the device is intended to serve for projecting electromagnetic radiation. If the heating device is controlled as a function of a temperature which can involve a temperature of the moveable element itself or an ambient temperature, a sensor can be provided for measurement thereof.

The moveable element will typically be a microactuator or a micromechanical resonator, the advantages of the invention then applying in particular when a vacuum-encapsulated element, for example in the form of a micromirror, is involved. In this case, thermal influences are particularly significant if they are not compensated for by the features of the present invention. The moveable element can also serve for example as sensor element of an inertia sensor. In this case, deflection of the moveable element can be detected for example capacitively or optically. Typically, the moveable element forms however a beam deflection unit for a projection device. The subsequent embodiments relate mostly to this case, the features described in this context not however being restricted to this application.

In order to achieve as constant thermal conditions as possible, the control unit can preferably be designed to actuate the heating device by means of a control circuit such that a temperature of the moveable element is maintained at a prescribed and/or constant value.

The proposed device, as already indicated, can form a device for projecting electromagnetic radiation, which has an intensity-modulatable radiation source, the moveable element being designed as a beam deflection unit for deflecting radiation emanating from the radiation source towards a projection surface and the beam deflection unit being actuatable in order to prescribe a time-dependent instantaneous projection direction. The control unit in this case is preferably designed to actuate the heating device as a function of an instantaneous radiation intensity of the radiation source.

Irrespective of the application of a device of the type proposed here, the heating device can be provided by an electrical conductor which is disposed on the moveable element or in the vicinity of the moveable element and can be supplied with a heating current which can be controlled by the control device. This conductor can be provided for example in a strip conductor plane on the moveable element if the latter is formed by a correspondingly structured semiconductor substrate. Alternatively, the heating device can be provided by an intensity-modulatable secondary source for irradiating the moveable element, the control unit then being designed to control a radiation intensity of the secondary source.

If the device has a likewise intensity-modulatable secondary source for irradiating the beam deflection unit, in addition a control unit being provided for controlling a radiation intensity of a secondary source as a function of an instantaneous radiation intensity of the radiation source, an extensively constant energy input into the beam deflection unit can be achieved, despite a temporally changing irradiation of the beam deflection unit. As a result, temperature variations in the beam deflection unit can in turn be avoided, which variations would otherwise influence the mechanical properties thereof at the expense of precision. Thus thermal stabilisation of the beam deflection unit serving as beam deflection system can be achieved, whilst complex correction of the actuation of the radiation source itself and/or of the beam deflection unit becomes superfluous. Therefore, as a result of the invention, an instantaneous temperature adjustment can be achieved.

With the proposed device and also the corresponding method, it is possible in the preferred embodiments to react with a correspondingly small delay in fact to the difference in intensities of only two adjacent pixels. The temperature problem portrayed further back is therefore resolved without the quality of the projection task being impaired because the radiation source provided for the projection can be actuated, thanks to compensation of intensity changes, by the secondary source without taking into account thermal effects.

A device of the proposed type can be used, according to design and requirement, for image generation or material processing on a workpiece surface forming the projection surface. The control unit is typically designed by programming technology such that the radiation intensity of the secondary source increases if the irradiation intensity of the beam deflection unit by the radiation source reduces and vice versa, hence the desired effect is achieved.

In the case of the corresponding method for projecting electromagnetic radiation which can be implemented with a device of this type, radiation emanating from a radiation source is intensity-modulated and deflected towards the projection surface by means of a beam deflection unit, the beam deflection unit being actuated such that the radiation emanating from the radiation source, with a temporally changing projection direction, impinges on different positions on the projection surface. In addition, the beam deflection unit is now heated with an intensity-modulatable heating device which is actuated such that a heating power of the heating device reduces when an increasing radiation intensity of the radiation source and/or a frequency change in the radiation emanating from the radiation source leads to an increased heat input into the beam deflection unit and vice versa.

For this purpose, the beam deflection unit can be irradiated for example with an intensity-modulatable secondary source which is actuated such that a radiation intensity of the secondary source reduces when an increasing radiation intensity of the radiation source and/or a frequency change in the radiation emanating from the radiation source leads to an increased heat input into the beam deflection unit and vice versa. Instead, also an electrical conductor can be used as heating device, which conductor is supplied with a correspondingly controlled heating current.

Preferably, the secondary source is thereby actuated such that the radiation source and the secondary source effect together a temporally constant heat input into the beam deflection unit in that the secondary source is intensity-modulated in synchronisation with the radiation source.

For typical applications of the invention, the radiation source and/or the secondary source can be a light source radiating in a wavelength range between ultraviolet and infrared. It can be advantageous if the secondary source is a light- or heat radiation source radiating in a non-visible wavelength range in order that radiation emanating from the secondary source cannot interfere with a generated image.

The radiation source can be intensity-modulatable directly or indirectly by means of a subsequently connected modulation unit. It can comprise in particular a laser diode or an RGB laser light source or an infrared laser.

It applies equally for the secondary source that it can be intensity-modulatable directly or by means of a subsequently connected modulation unit. The secondary source should thereby be intensity-modulatable with a maximum frequency which is at least as high as a maximum modulation frequency of the radiation source in order that changing radiation intensities can be compensated for by the radiation source without a delay. The secondary source can comprise in particular an infrared laser diode or a near infrared laser diode.

The beam deflection unit can be provided in fact in theory also by a refractive element, however it has a reflecting configuration in typical embodiments of the invention. A simple construction is produced if the beam deflection unit comprises a mirror which can be tilted about one or two axes. In particular, the beam deflection unit can comprise a micromirror produced e.g. on a silicon base and form for example a micromirror scanner. For the beam deflection unit and the type of actuation thereof and the image generation achieved therewith, any of the embodiments are possible which were mentioned in the introductory part in connection with the state of the art. For further details, reference can be made in this respect to the publications mentioned there.

The secondary source is preferably disposed such that it irradiates the beam deflection unit from a rear-side in order that radiation emanating from the secondary source is not reflected onto the projection surface. The secondary source can irradiate the beam deflection unit also in another way such that radiation emanating from the secondary source which is deflected by the beam deflection unit does not impinge on the projection surface. This can be achieved for example in that the secondary source irradiates the beam deflection unit from a direction deviating by a sufficiently large angle, e.g. by at least 20°, from an irradiation direction by means of the radiation source.

The time-dependent radiation intensity of the secondary source can be defined in a simple manner in that an instantaneous intensity value of the radiation source is subtracted from a reference value, a consequently produced difference value is weighted with a weighting factor and a thus obtained actuation signal is used for actuating the secondary source. For this purpose, the control unit of the device can be designed correspondingly by programming technology. If the radiation source comprises a plurality of light sources, for example in order to produce different colour components, the mentioned intensity value of the radiation source can thereby be determined in that each individual intensity of the light sources contained in the radiation source is weighted with a colour-specific weighting factor and the thus weighted individual intensities are added. As a result, frequency-dependent absorption properties of the beam deflection unit can be taken into account.

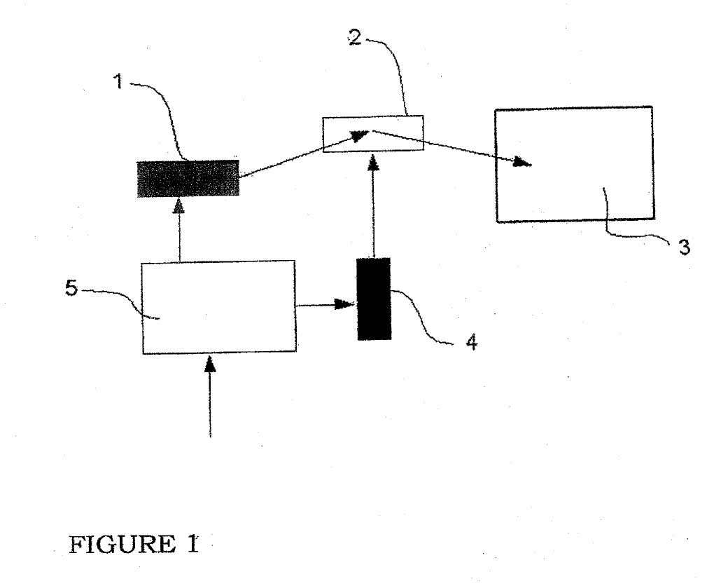

Embodiments of the invention are described subsequently with reference to FIGS. 1 to 4. There are shown

FIG. 1 a schematic representation of an embodiment of the invention,

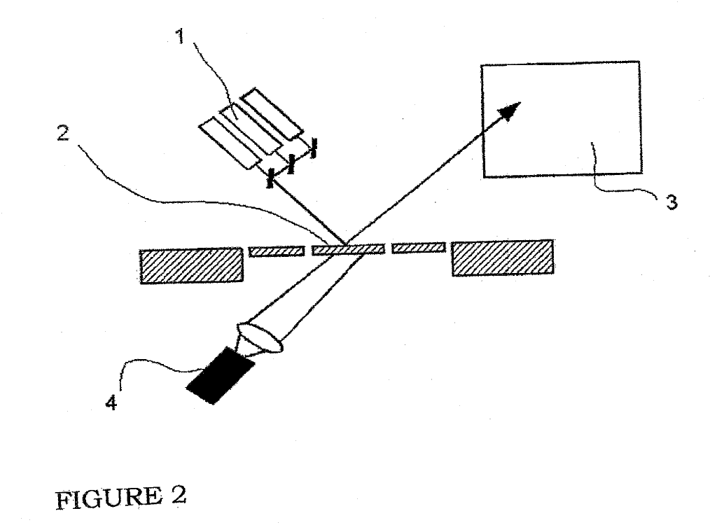

FIG. 2 likewise schematically but in somewhat more detail, a device in an embodiment of the invention,

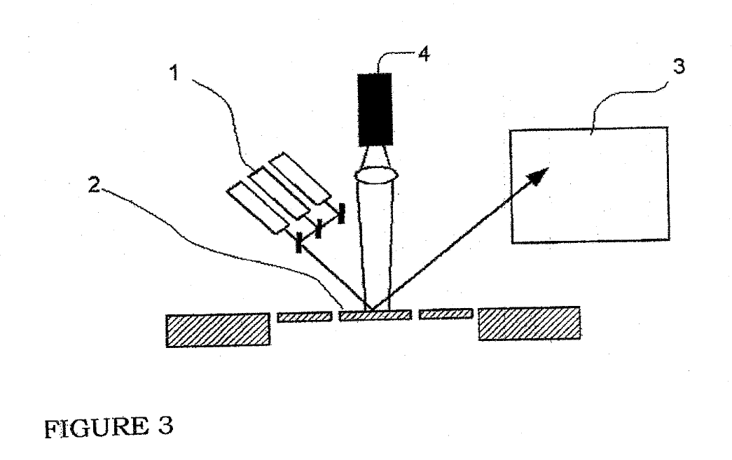

FIG. 3 a different embodiment of the invention in the representation corresponding to FIG. 2 and

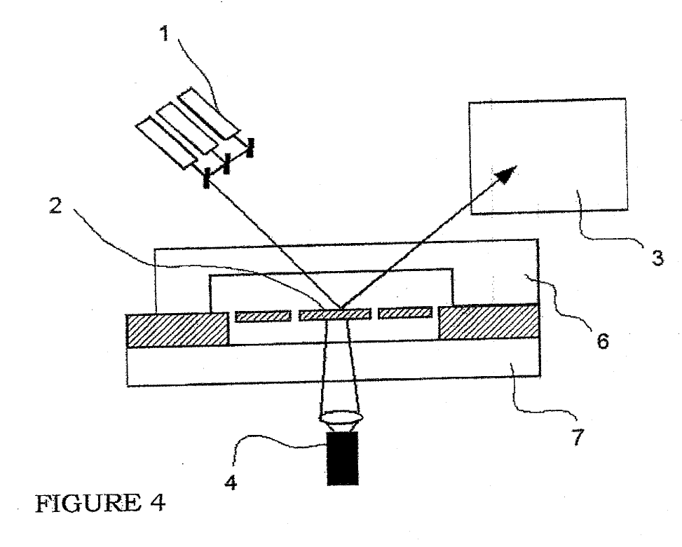

FIG. 4 in a comparable representation, a further embodiment of the invention,

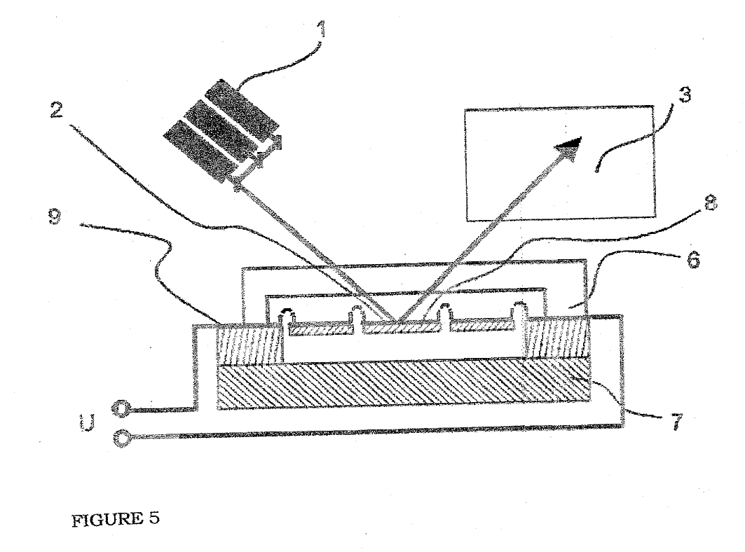

FIG. 5 a corresponding representation of a modification of the embodiment of FIG. 4 and

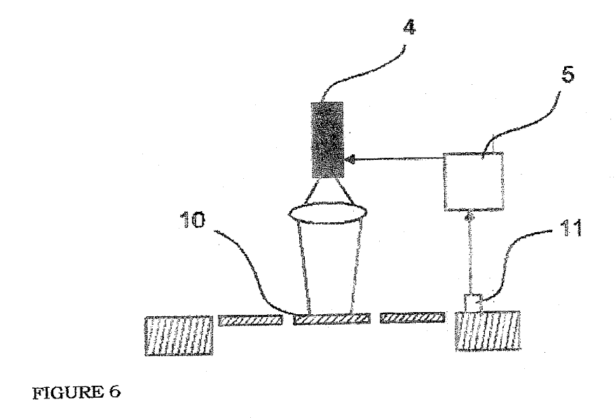

FIG. 6 a corresponding representation of another embodiment of the present invention.

The device shown in FIG. 1 forms a projection apparatus for resolving the initially portrayed problem and provides a radiation source 1 which comprises one or more primary sources of electromagnetic radiation which is or are specifically modulatable with respect to the output power thereof. This can be respectively a directly modulatable source, such as for example a laser diode which can be controlled by the current or else a CW source (thus “a continuous wave source” which radiates in particular with a constant frequency and amplitude), the output radiation of which is intensity-modulated by a subsequently connected modulator. An example of such a primary source is the RGB laser light source of a full-colour laser video projector or else also an infrared laser used for writing purposes.

For some applications for which this invention is of relevance, it is necessary to influence the radiation emitted by the radiation source 1 or by the primary source or sources firstly by a suitable beam forming unit (lens system) in the desired manner (e.g. by collimation of a divergent radiation source).

A beam deflection unit 2 is provided in the apparatus in order to enable a one- or multidimensional deflection of the intensity-modulated radiation. For scanning image projection, this can be a biaxial beam deflection system which comprises for example two successively connected uniaxial specifically moveable deflection mirrors. However, it can just as well be also a single mirror which is moveable about two or more axes or also a different deflection apparatus which makes it possible to deflect the output beam of the primary source or the primary sources specifically at least vertically and horizontally. For other projection tasks, also a different type of beam deflection, for example merely uniaxial (line projection), can be desired without restriction.

The radiation deflected by the beam deflection unit 2 is projected directly onto a projection surface 3. According to the application, the projection surface can be configured in various ways, thus for example in the case of an imaging laser projection process which projects onto or projects back as a reflecting or also transmitting, generally also a scattering projection screen. In the case of a projection for material processing, the projection surface 3 can concern various other materials and surfaces which are to be processed by the deflected radiation.

In addition to the radiation source 1 also termed primary source unit, there is provided, in the apparatus proposed here, at least one secondary source 4 which is likewise specifically modulatable with respect to the output intensity, and in fact with a maximum frequency which preferably is at least just as high as the highest modulation frequency of the radiation source 1 which is used for the projection task. For scanning image projection with e.g. VGA resolution, a modulation frequency of a few MHz is required.

The secondary source 4 need not be a component of the projection task (image projection or material processing, etc.). In preferred embodiments of the invention (see e.g. FIG. 2), the radiation emitted by the secondary source 4 is therefore not projected onto the projection surface 3.

A control unit 5 (also termed control unit) receives (illustrated in FIG. 1 by an arrow coming from the bottom) projection data which can concern for example sequential RGB video data or else for example also one- or multidimensional data for material processing. Generally, it involves intensity information as a function of which the radiation source 1 is actuated. The control unit 5 has the task of receiving and storing the data intermediately and, in evaluation of these data, actuating the radiation source 1 in synchronisation with the beam deflection unit 2. Whilst a control signal for the radiation source 1 is generated in the control unit 5 from the input data, the same control unit 5 based on the same instantaneous input data, also calculates an instantaneous actuation signal value for actuation of the secondary source 4. This actuation signal value for the secondary source 104 is calculated in the simplest case as follows:

Step 1: If the radiation source 1 comprises a plurality of individual sources which are actuated independently of each other, such as for example in the case of a white light laser source of a video laser projection system, comprising a red, a green and a blue light source, then firstly the instantaneously present intensity value of each of these different primary source channels is multiplied with a weighting factor. This weighting factor can be produced from experimentally obtained data and take into account for example the spectrally different absorption properties of the beam deflection system, thus the beam deflection unit 2. Thus for example short-wave blue light from an aluminium reflection layer is absorbed more greatly than green or red light. Consequently, with respect to the temperature problem portrayed further back, the instantaneous intensity values for a blue primary source would have to be weighted more strongly than those for green and for red. However, the weighting can also furthermore take into account further experimentally detected influences. Thus it would be possible to take into account also the dependency of the spectral absorption upon changing angles of incidence on a moving mirror plate in the weighting. As long as the radiation source 1 comprises only one single source of electromagnetic radiation, the spectral weighting can be dispensed with.
Step 2: In the case where the radiation source 1 comprises a plurality of individual sources, the weighted instantaneous individual intensity values are added up to form an instantaneous total intensity value.
Step 3: The determined total intensity value is subtracted from a prescribed reference value. This reference value is thereby at least as high as the sum of the weighted maximum intensity values of all the individual sources from the radiation source 1.
Step 4: The thus calculated instantaneous value always behaves proportionally to the energy input into the beam deflection unit 2, which input is missing in order to keep the beam deflection unit 2 permanently at a constant temperature. The thus determined difference value is likewise multiplied with a weighting factor. The weighting factor is produced for example from experimentally obtained data relating to the absorption property of the beam deflection system during irradiation with radiation of the secondary source 4.
Step 5: Finally, based on the thus just obtained instantaneous value, an actuation signal for the secondary source 4 is generated and the beam deflection system is correspondingly actively heated and hence retained at an approximately constant temperature not only averaged over large periods of time but also on the timescale of pixel illumination times.

Recurring features are always designated with the same reference numbers in the further Figures.

The device shown in FIG. 2 forms an RGB laser display, based on an RGB primary source as radiation source 1 and on a biaxial micromirror scanner produced from silicon as beam deflection unit 2. The deflected light of the radiation source 1 impinges on the projection surface 3. The secondary source 4, preferably a near infrared laser diode (with a wavelength between 700 nm and 800 nm) is directed towards an uncoated rear-side of the silicon micromirror which forms the beam deflection unit 2.

The device shown in FIG. 3 is another RGB laser display, based on an RGB primary source as radiation source 1 and on a biaxial micromirror scanner produced from silicon as beam deflection unit 2. The deflected light of the radiation source 1 impinges on the projection surface 3. The secondary source 4, preferably a near infrared laser diode with a wavelength between 700 nm and 800 nm, is directed here likewise towards the silvered front-side of the silicon micromirror 2. The efficiency of the heat radiator is, in this arrangement, however significantly less because of the high reflectivity than in the arrangement of FIG. 2. If the secondary source 4 is an emitter of a non-visible near infrared wavelength, the radiation thereof could be deflected towards the projection surface 3 without interfering with the contrast of the laser image projection. Differently from the representation here, this would be the case with correspondingly angled incidence of this radiation on the mirror.

Also the device represented in FIG. 4 forms an RGB laser display, based on an RGB primary source as radiation source 1 and a biaxial micromirror scanner produced from silicon as beam deflection system or beam deflection unit 2. The deflected light of the primary source provided by the radiation source 1 impinges on the projection surface 3. The secondary source 4, preferably a near infrared laser diode (therefore radiating again with a wavelength between 700 nm and 800 nm) is directed towards the non-silvered rear-side of the silicon micromirror which forms the beam deflection unit 2. The silicon micromirror scanner represented here is packaged hermetically and vacuum-encapsulated, for which purpose it is surrounded on both sides by glass surfaces 6 and 7 which require to be radiated through.

The embodiments in any combination can also have all the further features which are explained in the general part of the description.

In the invention just described with reference to the embodiments of FIGS. 1 to 4, an arrangement of apparatus and a method is proposed for one- or multidimensional projection of electromagnetic radiation. The relevant wavelengths and power ranges for which the invention can be applied thereby comprise at least all the wavelengths and powers which can be suitably deflected with metallic or dielectric mirrors without the result thereby being destruction of the deflection mirror or of the deflection mirrors. The arrangement comprises at least two or else also a plurality of sources, namely at least the radiation source 1 and the secondary source 4, the emitted electromagnetic radiation of which can be modulated in intensity either directly or else indirectly via a subsequently connected unit. The intensity modulation is controlled by one, two or several electronic control units 5 corresponding to supplied one- or multidimensional image data information.

The intensity-modulated beam of at least one of these sources can be deflected in a controlled manner by means of a uniaxial or multiaxial deflection unit, termed here beam deflection unit 2, and be directed either directly towards the provided projection surface 3 or else e.g. indirectly via a subsequently connected imaging device (lens) towards the projection surface 3. At least one of the intensity-modulatable sources of electromagnetic radiation does not serve or at least not primarily for the projection task (e.g. image projection or material processing) but is provided for the purpose of transmitting energy, imparted by absorption, to one or else several deflection units. As a result, the temperature of the one or more deflection units can be kept constant temporally not only on the scale of all the images or all the lines but substantially even more precisely on the scale of the elementary components of lines, namely of pixels.

FIG. 5 shows a modification of the embodiment of FIG. 4, instead of the secondary source 4 which serves in the previously described embodiments as heating device, a different heating device is provided here in which an electrical conductor 8 is disposed on the beam deflection unit 2 and is supplied with a heating current by applying a correspondingly controlled voltage U, a control device not illustrated here (and corresponding to the control device 5 of FIG. 1) actuating the heating device—as in the other embodiments the secondary source 4—by means of a control circuit such that a temperature of the beam deflection unit 2 is maintained constantly at a prescribed value. As also in the previously described embodiments, the—typically changing pixel-wise—current intensity of the radiation by the radiation source 1 and the thus associated heat input is thereby taken into account and compensated for by a corresponding heating power of the heating device. The electrical conductor 8 serving as heating wire is produced by corresponding structuring of a strip conductor plane 9. This strip conductor plane 9 is disposed on a semiconductor substrate, on the basis of which and as a result of the structuring of which the beam deflection unit 2 is formed.

In the previously described embodiments, respectively one beam deflection unit 2 is shown as moveable element of a micromechanical device which serves for projecting electromagnetic radiation. In other embodiments of the invention, instead other moveable elements can be maintained at a constant temperature by corresponding heating devices and correspondingly designed control devices in order to keep the mechanical properties of these moveable elements constant. In general, the moveable elements respectively concern mechanical microactuators and/or resonators, a temperature-, frequency- and phase stabilisation being able to be achieved by the compensation of thermal influences which is proposed here.

FIG. 6 shows a last embodiment which forms an inertia sensor, the moveable element here being formed by a sensor element 10 which is formed on the basis of a semiconductor substrate and is suspended elastically, acceleration-related deflections of the sensor element 10 being able to be detected optically or capacitively. A temperature sensor 11 is likewise provided here, with which temperature sensor temperature changes of the sensor element 10 can be directly detected. A control device 5 controls the secondary source 4 which corresponds to the embodiments of FIGS. 1 to 4 and serves as heating device by means a control circuit such that the temperature of the sensor element 10 is kept constant at least on a temporal average. Instead of the secondary source 4 (the term secondary source is used here in general for radiation sources provided for the purposes of temperature control even if the device itself has no primary source) again a different heating device can be used of course in a modification, for example an electrical conductor correspondingly supplied with current, as in the embodiment of FIG. 5.

The temperature stabilisation of micromechanical elements by heating devices which are actuated, as a function of a—for example measured—temperature and/or of a heat input produced by other measures, such that influences which otherwise would lead to a temperature change are compensated for is common to the various embodiments of the present invention. The invention can be applied in particular to vacuum-packaged microactuator- and/or micromechanical resonators which can concern for example deflectable micromirrors. If a secondary source is thereby used as heating device, then the latter is in any case not comparable with a radiation source which is possibly provided in order to project electromagnetic radiation acting together with the micromirror. In this case, the secondary source is preferably disposed such that radiation emanating from it, as long as it is reflected on the moveable element, is cast in any case in a clearly different direction from the radiation which emanates from the actual current source. Alternatively or additionally, the secondary source can, for this purpose, also operate in a significantly different wavelength range from the radiation source which serves for generating the projected radiation. By means of corresponding actuation of the heating device and the thus achieved uniform temperature control, firstly a change in mechanical (and not primarily optical) properties of the micromechanical device is thereby avoided, in particular a change in mechanical resonance properties of the moveable element.

1-24. (canceled)

25. A micromechanical device, comprising:
a moveable element;
a controllable heating device including a predefined heat input into the moveable element; and
a control unit controlling the heating device as a function of at least one of an instantaneous temperature and an instantaneous different heat input into the moveable element.

26. The device according to claim 25, wherein the moveable element includes at least one of a microactuator and a micromechanical resonator.

27. The device according to claim 25, wherein the control unit actuates the heating device using a control circuit such that a temperature of the moveable element is maintained at least one of a predetermined value and a constant value.

28. The device according to claim 25, wherein the device includes a device for projecting electromagnetic radiation which includes an intensity-modulatable radiation source, the moveable element being a beam deflection unit deflecting radiation emanating from the radiation source towards a projection surface and the beam deflection unit being actuatable to prescribe a time-dependent instantaneous projection direction.

29. The device according to claim 28, wherein the control unit actuates the heating device as a function of an instantaneous radiation intensity of the radiation source.

30. The device according to claim 25, wherein the heating device includes an electrical conductor which is one of (a) disposed on the moveable element and (b) in the vicinity of the moveable element, the conductor being supplied with a heating current which is controlled by the control device.

31. The device according to claim 25, wherein the heating device includes an intensity-modulatable secondary source for irradiating the moveable element, the control unit controlling a radiation intensity of the secondary source.

32. The device according to claim 28, wherein the control unit is configured such that a heating power of the heating device increases if the irradiation intensity of the beam deflection unit by the radiation source decreases and vice versa.

33. The device according to claim 31, wherein the secondary source includes one of a light radiation source and a heat radiation source radiating in a non-visible wavelength range.

34. The device according to claim 31, wherein the secondary source includes one of an infrared laser diode and a near infrared laser diode.

35. The device according to one of claims 31, wherein the secondary source is one of intensity-modulatable directly and using a subsequently connected modulation unit.

36. The device according to claim 35, wherein the secondary source is intensity-modulatable with a maximum frequency which is at least as high as a maximum modulation frequency of the radiation source.

37. The device according to claim 25, wherein the moveable element has a reflecting configuration.

38. The device according to claim 25, wherein the moveable element includes a mirror which is configured to be tilted about at least one axe.

39. The device according to claim 25, wherein the moveable element at least one of (a) includes a silicon micromirror and (b) forms a micromirror scanner.

40. The device according to claim 31, wherein the secondary source is disposed such that it irradiates the beam deflection unit from at least one of (a) a rear-side and (b) a direction deviating by at least 20° from an irradiation direction by the radiation source.

41. A method for projecting an electromagnetic radiation, comprising:
emanating intensity-modulated radiation from a radiation source;
deflecting the radiation towards a projection surface using a beam deflection unit, the beam deflection unit being actuated such that the radiation emanating from the radiation source with a temporally changing projection direction, impinges on different positions on the projection surface; and
heating the beam deflection unit with an intensity-modulatable heating device, the heating device being actuated such that a heating power of the heating device reduces with at least one of (a) an increasing radiation intensity of the radiation source and (b) a frequency change in the radiation emanating from the radiation source leading to an increased heat input into the beam deflection unit and vice versa.

42. The method according to claim 41, wherein the beam deflection unit is irradiated with an intensity-modulatable secondary source, the secondary source serving as a heating device and being actuated such that a radiation intensity of the secondary source which defines the heating power reduces with at least one of (a) an increasing radiation intensity of the radiation source and (b) a frequency change in the radiation emanating from the radiation source leading to an increased heat input into the beam deflection unit and vice versa.

43. The method according to claim 41, wherein the radiation source and the heating device effect together a temporally constant heat input into the beam defection unit using an intensity modulation of the heating device in synchronization with the radiation source.

44. The method according to claim 41, wherein the beam deflection unit reflects the radiation emanating from the radiation source with a mirror which is pivoted about the at least one axis.

45. The method according to claim 42, wherein the secondary source irradiates the beam deflection unit from a rear-side.

46. The method according to claim 42, wherein the radiation emanating from the secondary source which is deflected by the beam deflection unit does not impinge on the projection surface.

47. The method according to claim 41, wherein a time-dependent heating power of the heating device is configured such that an instantaneous intensity value of the radiation source is subtracted from a reference value, a consequently produced difference value is weighted with a weighting factor and a thus obtained actuation signal is used for actuating the heating device.

48. The method according to claim 47, wherein the intensity value of the radiation source is determined in that each individual intensity of a plurality of light sources contained in the radiation source is weighted with a color-specific weighting factor and the thus weighted individual intensities are added.
